(19) United States
(12) Patent Application Publication
(10) Pub. No.: US 2020/0156746 A1
(43) Pub. Date: May 21, 2020

(54) SNORKEL ASSEMBLY FOR UNDERWATER EXERCISE

(71) Applicant: QBAS CO., LTD., Taipei (TW)

(72) Inventor: Chih-Cheng SHIUE, Taipei (TW)

(21) Appl. No.: 16/685,025

(22) Filed: Nov. 15, 2019

Related U.S. Application Data
(60) Provisional application No. 62/768,130, filed on Nov. 16, 2018.

(30) Foreign Application Priority Data
Apr. 17, 2019 (TW) 108204664

(51) Int. Cl. B63C 11/20; F16K 1/12

(52) U.S. Cl. CPC B63C 11/205; F16K 1/126

(57) ABSTRACT

A snorkel assembly for underwater exercise including a snorkel tube, a mouthpiece portion and a valve seat is provided. The mouthpiece portion is configured to connect to and be in gas-communication with the snorkel tube. The valve seat is disposed in the snorkel tube or between the snorkel tube and the mouthpiece portion. The valve seat comprises a valve piece and a seat portion. The buckle portion of the valve piece is buckled to a buckle seat of the seat portion. The valve piece hangs on the seat portion with the buckle seat as a fulcrum. The valve piece is in a normally-open state when bearing no pressure, and is closed only when a user exhales.

### CROSS-REFERENCES TO RELATED APPLICATIONS

This application claims priority to U.S. Provisional Patent Application No. 62/768,130 filed on Nov. 16, 2018 and Taiwan Patent Application No. 108204664 filed on Apr. 17, 2019, which are hereby incorporated by reference in their entirety.

### BACKGROUND OF THE INVENTION

### Field of the Invention

The present invention provides a snorkel assembly. In particular, it provides a snorkel assembly for underwater exercise.

### Descriptions of the Related Art

As shown in FIG. 1, in a snorkel 60 disclosed in the related art U.S. Pat. No. 6,516,797, a valve piece 42 and a one-way valve 30 are respectively disposed at the upper right side and lower left side of a chamber 50 thereof so that the user can breathe fresh air and discharge the exhaled air and the accumulated water.

The valve piece 42 disposed on the upper right side of the chamber 50 is pivotably fixed on a hard material 40. The valve piece 42 is opened or closed with respect to the hard material 40 depending on the change in pressure inside the snorkel 60.

The one-way valve 30 disposed on the lower left side of the chamber 50 is in a normally-closed state. It is opened only when the pressure inside the chamber 50 is larger than the pressure outside the snorkel 60.

In detail, as shown in FIG. 1, when the user puts the mouth thereof at the mouthpiece 20 to inhale, the air pressure inside the chamber 50 will decrease because the one-way valve 30 on the lower left side is in the normally-closed state. Thus, the air on the right side of the valve piece 42 has a relatively large pressure and will push the valve piece 42 open so that fresh air can flow into the chamber 50. On the contrary, when the user puts the mouth thereof at the mouthpiece 20 to exhale, the air pressure inside the chamber 50 will increase so that the air on the left side of the valve piece 42 has relatively large pressure and will push the valve piece 42 closed. Thereafter, the continuously increasing pressure will cause the one-way valve 30 to open, thereby, discharging the exhaled air and accumulated water at the lower part of the chamber 50.

Because the valve piece 42 is made of a hard material, and the valve piece 42 pivotably opens or closes, it is very hard to control the opening or closing of the valve piece 42 by changing the pressure inside the snorkel 60 via inhaling or exhaling. This is especially true of a beginner of which the vital capacity is insufficient. As a result, it is harder to open or close the valve piece 42 via inhaling or exhaling, thereby, seriously affecting the security.

Accordingly, it is important to provide a snorkel assembly which can control the opening and closing of the valve piece more easily to improve the aforesaid drawbacks.

### SUMMARY OF THE INVENTION

An objective of the present invention is to provide a snorkel assembly for underwater exercise which is easy to manufacture and use, and is capable of effectively improving the use security.

To achieve the aforesaid objective, a snorkel assembly of the present invention comprises a snorkel tube, a mouthpiece portion and a valve seat. The mouthpiece portion is configured to connect to and be in gas-communication with the snorkel tube. The valve seat is disposed on the snorkel tube or between the snorkel tube and the mouthpiece portion. The valve seat comprises a valve piece and a seat portion. The buckle portion of the valve piece is buckled to a buckle seat of the seat portion. The valve piece hangs on the seat portion with the buckle seat as a fulcrum. The valve piece is in a normally-open state when bearing no pressure, and is closed only when the user exhales.

To achieve the aforesaid objective, the valve piece included in the snorkel assembly of the present invention comprises a first area, a second area, and a third area in top-down sequence defined from the buckle portion. The first to third areas are adjacent to each other. The thickness of the first area is between 0.05 mm and 0.5 mm. Thickness of the second area is between 0.1 mm and 1 mm. The thickness of the third area is between 0.1 mm and 1 mm.

To achieve the aforesaid objective, the valve piece included in the snorkel assembly of the present invention is formed from silicone rubber, rubber or thermoplastic elastomer (TPE). The hardness thereof ranges from Shore 10A to 60A.

To achieve the aforesaid objective, the opening angle between the valve piece and the valve seat included in the snorkel assembly of the present invention is between 3 degrees and 45 degrees.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a valve seat of the prior art;

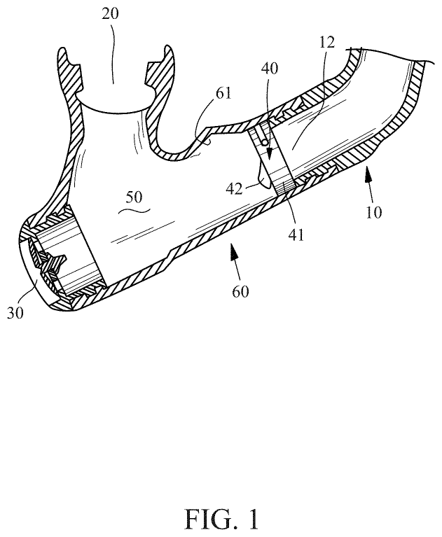

FIG. 2 is a perspective view of a snorkel assembly for underwater exercise according to the present invention;

FIG. 3 is an assembled view of a valve seat included in the snorkel assembly for underwater exercise according to the present invention;

FIG. 4 to FIG. 5 are schematic views of a valve piece and a seat portion of the valve seat included in the snorkel assembly for underwater exercise according to the present invention;

FIG. 6 is a schematic view of an embodiment where the valve seat is mounted in a snorkel tube in the snorkel assembly for underwater exercise according to the present invention; and

FIG. 7 is a schematic view of another embodiment where the valve seat is mounted in the snorkel tube in the snorkel assembly for underwater exercise according to the present invention.

### DESCRIPTION OF THE PREFERRED EMBODIMENT

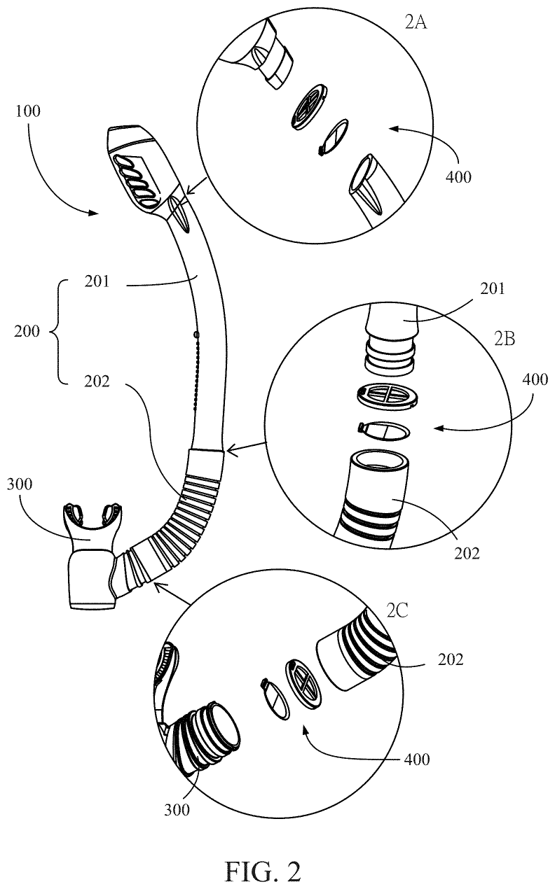

FIG. 2 is a schematic view of a snorkel assembly 100 for underwater exercise according to the present invention. The snorkel assembly 100 comprises a snorkel tube 200, a mouthpiece portion 300 and a valve seat 400.

The mouthpiece portion 300 is configured to connect to (can be a direct or indirect connection) and be in gas-communication with the snorkel tube 200 (air/gas can flow from the mouthpiece portion 300 to the snorkel tube 200 and vice versa). The snorkel tube 200 may comprise a first tube 201 and a second tube 202 connected to each other, and the mouthpiece portion 300 is connected to an lower end of the second tube 202. The second tube 202 can be flexible (i.e. soft, or corrugated) to be bent by the user to some extent, so that the mouthpiece portion 300 connected to the flexible tube 202 can be positioned in the user's mouth easily. The second tube 202 and the mouthpiece portion 300 may be integratedly, or detachably, connected to each other. Alternatively, the snorkel tube 200 may comprises a first tube 201 which the mouthpiece portion 300 is connected to. The valve seat 400 is disposed on the snorkel tube 200 or between the snorkel tube 200 and the mouthpiece portion 300.

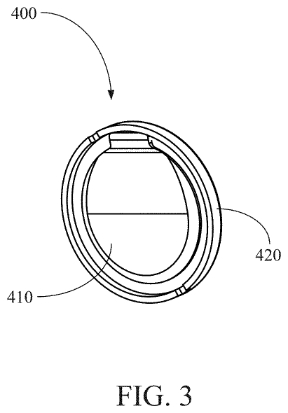

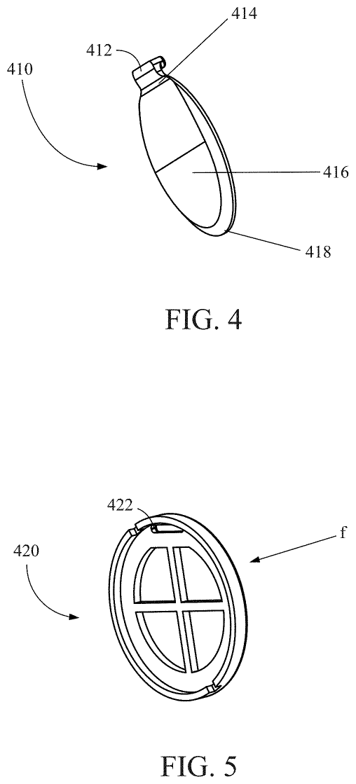

As shown in FIG. 3, the valve seat 400 comprises a valve piece 410 and a seat portion 420. As shown in FIG. 4 and FIG. 5, the buckle portion 412 of the valve piece 410 is buckled to a buckle seat 422 of the seat portion 420. The valve piece 410 hangs on the seat portion 420 with the buckle seat 422 as a fulcrum. In this way, since the valve piece 410 hangs on the seat portion 420 simply via a single fulcrum, the valve piece 410 is in a normally-open state when bearing no pressure and is closed only when a user exhales.

Still with reference to FIG. 4 and FIG. 5, the valve piece 410 comprised in the snorkel assembly 100 disclosed in the present invention is made of a soft material. It may be buckled to the buckle seat 422 of the seat portion 420 via the buckle portion 412 located at the upper end. Additionally, “f” depicted in FIG. 5 represents the air inflow direction when the user inhales.

As shown in FIG. 3 to FIG. 5, when the valve piece 410 is assembled to the seat portion 420, the valve piece 410 hangs on the seat portion 420 with the buckle portion 412 as a fulcrum. Because the valve piece 410 hangs on the buckle seat 422 located at the upper end of the seat portion 420 simply with the buckle portion 412 as a fulcrum, the valve of the present invention is in the normally-open state (i.e., a state where the valve piece 410 does not come in close contact with the seat portion 420) under the action of gravity.

In more detail, only when the pressure at the opposite side of the air inflow direction “f” (i.e., the left side of the valve seat 400) is larger than the pressure in the air inflow direction “f”, the valve piece 410 will be closed to the seat portion 420 under the action of the pressure at the left side of the valve seat 400. Otherwise, the valve piece 410 will be in the normally-open state.

Therefore, by using the snorkel assembly 100 according to the present invention, it is easy to acquire fresh air by inhaling, even for a beginner with insufficient vital capacity, thereby greatly reducing the security concern during the use of the snorkel assembly.

The valve piece 410 of the present invention comprises a first area 414, a second area 416, and a third area 418 in top-down sequence defined from the buckle portion. The first to third areas are adjacent to each other. The first area 414 is thinner and the thickness thereof is between 0.05 mm and 0.5 mm. The thickness of the second area 416 is between 0.1 mm and 1 mm. The thickness of the third area 418 is between 0.1 mm and 1 mm.

The valve piece 410 may be formed from silicone rubber, rubber or thermoplastic elastomer (TPE). The hardness thereof ranges from Shore 10A to 60A. An opening angle between the valve piece 410 and the seat portion 420 is between 3 degrees and 45 degrees.

With reference back to FIG. 2, the valve piece 410 of the present invention may be selectively disposed between the top of the snorkel tube 200 and the snorkel tube 200 (at 2A), between the snorkel tube 200 and a lower bent housing (at 2B), or between the lower bent housing and the mouthpiece portion 300 (at 2C).

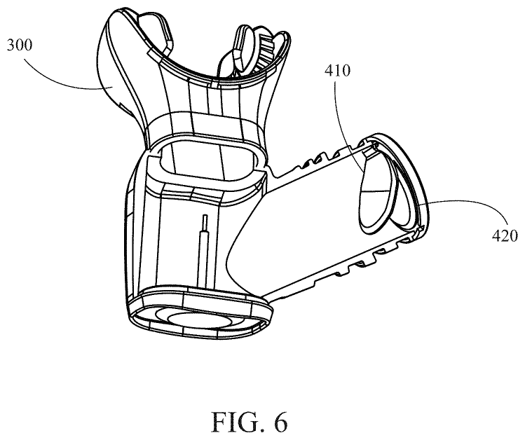

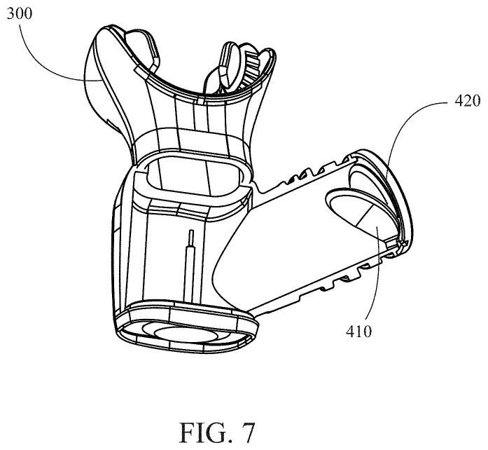

When the valve piece 410 is buckled to the seat portion 420, an opening formed by the valve piece 410 and the seat portion 420 may be in a downward opening as shown in FIG. 6, or may be in an upward opening as shown in FIG. 7. In either direction, the valve piece 410 of the present invention can achieve the effect of being in the normally-open state and is closed only when the user exhales due to the soft material thereof and under the action of gravity, thereby, improving the security during the use thereof.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A snorkel assembly for underwater exercise, comprising:
a snorkel tube;
a mouthpiece portion, being configured to connect to the snorkel tube; and
a valve seat, being disposed either in the snorkel tube, or between the snorkel tube and the mouthpiece portion,
wherein the valve seat comprises a valve piece and a seat portion, a buckle portion of the valve piece is buckled to a buckle seat of the seat portion, the valve piece is hanged on the seat portion with the buckle seat as a fulcrum, the valve piece is in a normally-open state when bearing no pressure, and is closed only when a user exhales.

2. The snorkel assembly according to claim 1, wherein the snorkel tube comprise a first tube and a second tube connected to each other, and the mouthpiece portion is connected to the second tube.

3. The snorkel assembly according to claim 2, wherein the second tube is flexible.

4. The snorkel assembly according to claim 1, wherein the snorkel tube is connected to the mouthpiece portion directly.

5. The snorkel assembly according to claim 1, wherein the valve piece comprises a first area, a second area, and a third area in top-down sequence defined from the buckle portion, the first to third areas are adjacent to each other, a thickness of the first area is between 0.05 mm and 0.5 mm, a thickness of the second area is between 0.1 mm and 1 mm, and a thickness of the third area is between 0.1 mm and 1 mm.

6. The snorkel assembly according to claim 1, wherein the valve piece is formed from silicone rubber, natural rubber, thermoplastic urethane (TPU), polyvinyl chloride (PVC) or thermoplastic elastomer (TPE), and a hardness thereof ranges from Shore 10A to 60A.

7. The snorkel assembly according to claim 1, wherein an opening angle between the valve piece and the valve seat is between 3 degrees and 45 degrees.
